(19) United States
(12) Patent Application Publication
(10) Pub. No.: US 2013/0014910 A1
(43) Pub. Date: Jan. 17, 2013

(54) HEAT DISSIPATING APPARATUS FOR ELECTRONIC DEVICE

(71) Applicants: MAO-HE ZHU, Wuhan City (CN); JIN-BIAO JI, Wuhan City (CN); ZHI-JIANG YAO, Wuhan City (CN)

(72) Inventors: MAO-HE ZHU, Wuhan City (CN); JIN-BIAO JI, Wuhan City (CN); ZHI-JIANG YAO, Wuhan City (CN)

(73) Assignees: HON HAI PRECISION INDUSTRY CO., LTD., Tu-Cheng (CN); HONG FU JIN PRECISION INDUSTRY (WUHAN) CO., LTD., Wuhan City (CN)

(21) Appl. No.: 13/414,856

(22) Filed: Mar. 8, 2012

(30) Foreign Application Priority Data
Jul. 12, 2011 (CN) 201110194324.X

(51) Int. Cl. F28F 9/00; F16B 23/00

(52) U.S. Cl. 165/47; 411/403; 411/407

(57) ABSTRACT

An installation member includes at least two installation portions located on the installation member, each defining an installation hole, at least two resilient members, at least two blocking members, and at least two fasteners. Each fastener comprises a head and a shank. The head defines a receiving groove for preventing a hand tool from disengaging from the head during rotating the fastener. The shank is received the installation hole. Each resilient member is fit on the shank and elastically engaged between the head and the installation portion. Each blocking member is secured on the shank and abuts against a nearest end of the installation portion.

### BACKGROUND

1. Technical Field

The present disclosure relates to heat dissipating apparatuses, and particularly to a heat dissipating apparatus for an electronic device.

2. Description of Related Art

Fasteners, such as screws may be configured to secure two objects together, such as, a heat dissipating apparatus and a computer main board. However, a tool such as an screwdriver is used to fasten and unfasten the screws. The screwdriver can easily slip from the screws when a force is applied and may cause damages to the main board or other parts around the main board as a result.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a heat dissipating apparatus.

FIG. 2 is an isometric view of a fastener of FIG. 1.

FIG. 3 is another angle view of FIG. 2.

FIG. 4 is an assembled view of the heat dissipating apparatus of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

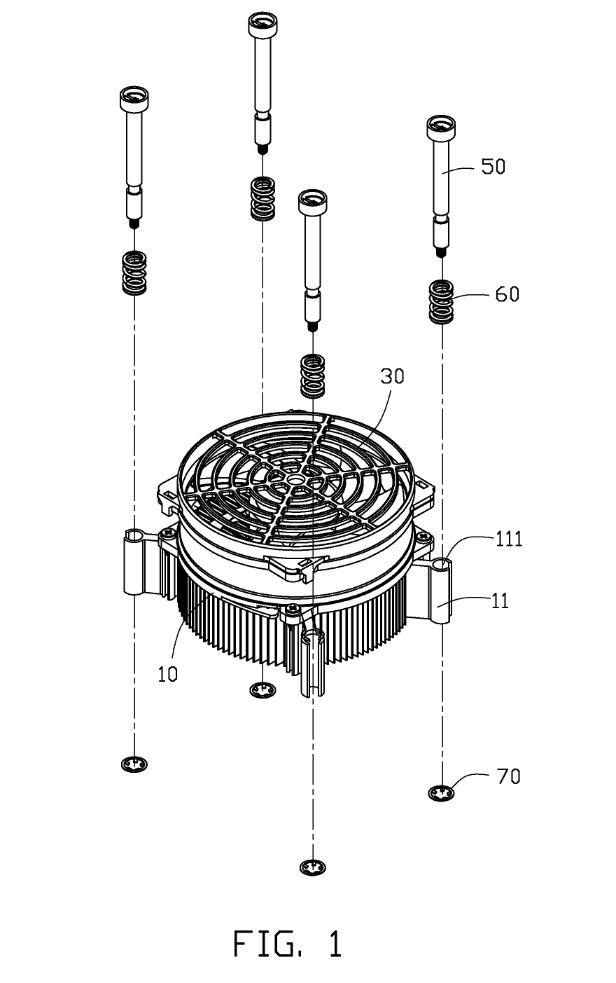

Referring to FIG. 1, a heat dissipating apparatus in accordance with an embodiment comprises an installation member 10, a fan 30 secured to the installation member 10, four fasteners 50, four resilient members 60, and four blocking members 70.

Four installation portions 11 are located on the installation member 10, and each of the four installation portions 11 defines a mounting hole 111.

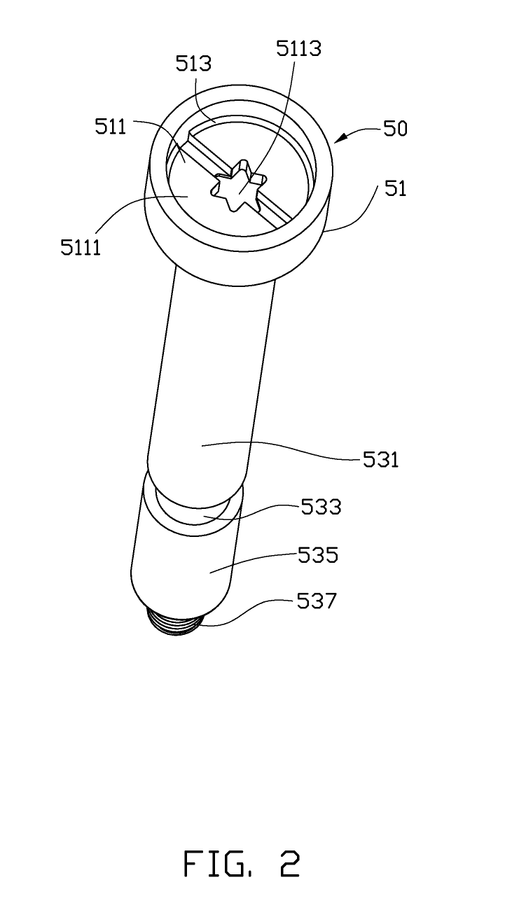

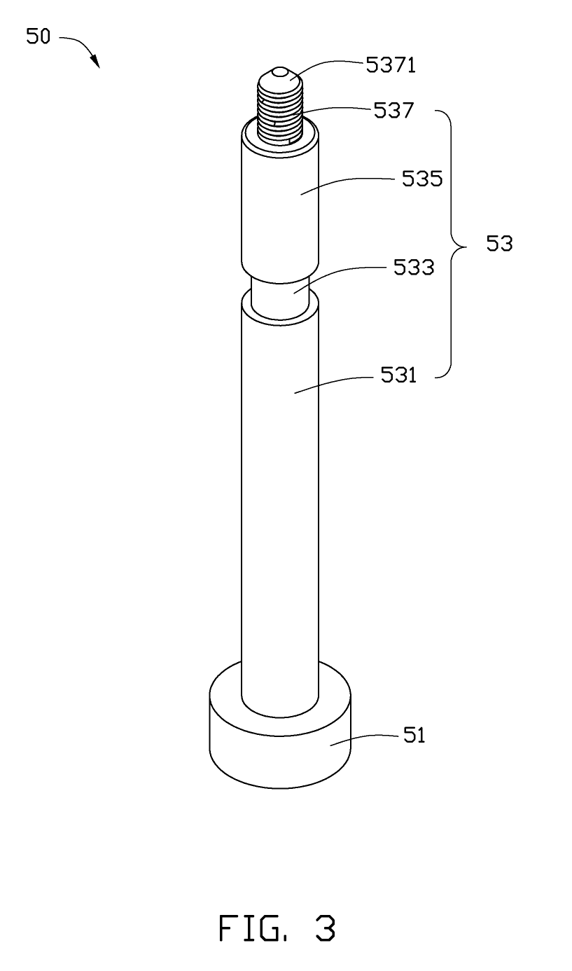

Referring to FIGS. 2-3, each of the four fasteners 50 includes a head 51 and a shank 53 extending from the head 51.

The head 51 includes a bottom wall 511 and a sidewall 513. The bottom wall 511 and the sidewall 513 corporately define a receiving groove 5111. An operating groove 5113 is defined in the bottom wall 511, and the operating groove 5113 communicates with the receiving groove 5111. The sidewall 513 is configured to prevent a hand tool (not shown) from disengaging from the fastener 50 when each of the four fasteners 50 is rotated by the hand tool. In one embodiment, the head 51 is substantially columnar, and the receiving groove 5111 is substantially circular.

The shank 53 includes a positioning portion 531, a stopper portion 533, a connecting portion 535, and a threaded portion 537. Each of the four fasteners 50 is configured as follows. The positioning portion 531 extends from the bottom wall 511. In one embodiment, a diameter of the positioning portion is smaller than a diameter of the head 51. The stopper portion 533 extends from the positioning portion 531. In one embodiment, a diameter of the stopper portion 533 is smaller than a diameter of the positioning portion 531. The connecting portion 535 extends from the stopper portion 533. In one embodiment, a diameter of the stopper portion 533 is smaller than a diameter of the connecting portion 535. The threaded portion 537 extends from the connecting portion 535. In one embodiment, the positioning portion 531, the stopper portion 533, and the connecting portion 535 are substantially columnar. The threaded portion 537 includes a tip 5371. In one embodiment, the tip 5371 is substantially conical.

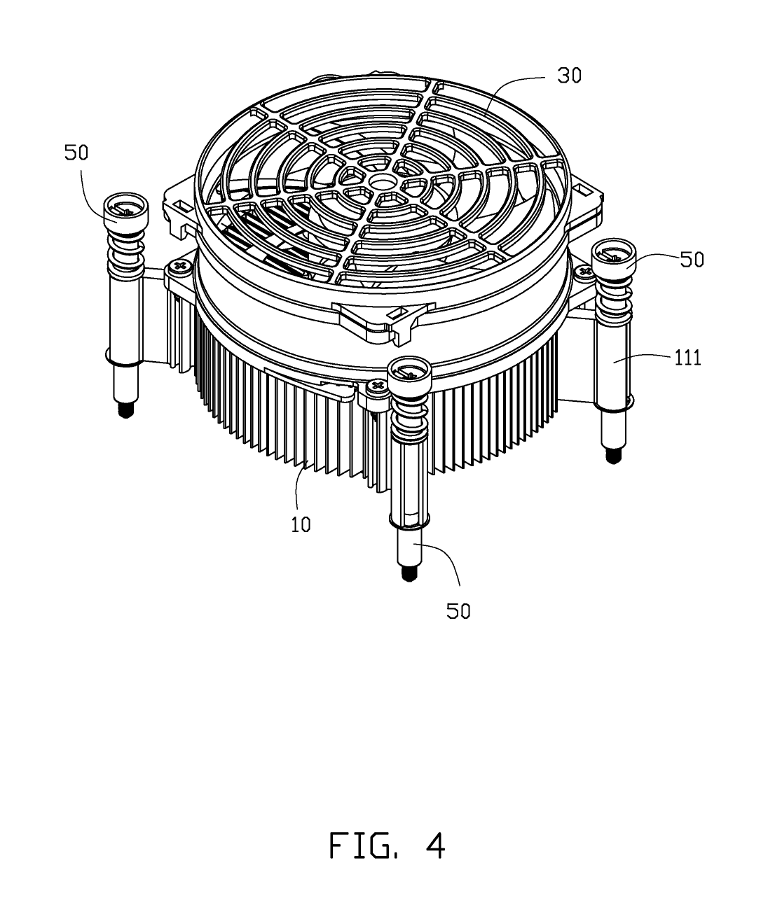

Referring to FIG. 4, in assembly, the four resilient members 60 are respectively engaged with the four fasteners 50, and the four fasteners 50 are then installed one at a time in the same manner, so only the installation of one is described. The threaded portion 537 of each of the four fasteners 50 is aligned with and extended through one of the mounting holes 111. Each of the four resilient members 60 is located between the head 51 and the mounting hole 111. The threaded portion 537 is extended through the mounting hole 111. Each of the four fasteners 50 is pressed to each of the four resilient members 60 elastically deform. The stopper portion 533 is thus exposed from the mounting hole 111. Each of the four blocking members 70 is engaged with the stopper portion 533. Each of the four fasteners 50 is released, and each of the four resilient members 60 is restored. Each of the four fasteners 50 is moved upward to each of the four blocking members 70 and abuts in a first end of each of the four installation portions 11. Each of the four resilient members 60 is located between the head 51 and a second end opposite to the first end of each of the four installation portions 11. Thus, each of the four fasteners 50 is elastically secured to the installation member 10.

In use, the heat dissipating structure is installed to a computer main board (not shown). The four fasteners 50 are engaged in corresponding through holes (not shown) defined in the main board, to secure the heat dissipating structure to the main board.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A heat dissipating apparatus comprising:
an installation member, at least two installation portions located on the installation member, each of the at least two installation portions defining an installation hole;
at least two resilient members;
at least two blocking members; and
at least two fasteners, each of the at least two fasteners comprising a head and a shank, the head defining a receiving groove configured to prevent a screwdriver from disengaging from the head when each of the at least two fasteners is rotated by the screwdriver, the shank being received in the installation hole, each of the at least two resilient members surrounding on each of the shanks and elastically engaged between the head and a first end of each of the at least two installation portions, and each of the at least two blocking members being secured to the shank and abutting a second end opposite to the first end of each of the at least two installation portions.

2. The heat dissipating apparatus of claim 1, wherein the shank comprises a positioning portion, and each of the at least two resilient members surrounds on the positioning portion.

3. The heat dissipating apparatus of claim 2, wherein each of the shanks further comprises a stopper portion extending from the positioning portion, and each of the at least two blocking member is engaged in the stopper potion.

4. The heat dissipating apparatus of claim 3, wherein the shank comprises a connecting portion, each of the at least two blocking members abuts the connecting portion.

5. The heat dissipating apparatus of claim 4, wherein the shank comprises a threaded portion extending from the connecting portion, and the threaded portion comprises a cone-shaped tip.

6. The heat dissipating apparatus of claim 2, wherein a diameter of the head is greater than a diameter of the positioning portion.

7. The heat dissipating apparatus of claim 4, wherein a diameter of the positioning portion is greater than a diameter of the stopper portion, and a diameter of the connecting portion is greater than the diameter of the stopper portion.

8. The heat dissipating apparatus of claim 1, wherein the receiving groove comprises a sidewall configured to prevent the screwdriver from disengaging from the head.

9. The heat dissipating apparatus of claim 8, wherein of the receiving groove further comprises a bottom wall, an operating groove is defined in the bottom wall, the operating groove is configured to accommodate the screwdriver rotating each of the at least two fasteners.

10. A fastener comprising:
a head, the head defining a receiving groove configured to prevent a screwdriver from disengaging from the head when the head is rotated by the screwdriver; and
a shank, the shank comprising a positioning portion, a stopper portion and a threaded portion, the positioning portion extending from the positioning portion, the connecting portion extending from the stopper portion, the threaded portion extending from the connecting portion, a diameter of the head being greater than a diameter of the positioning portion, the diameter of the positioning portion being greater than a diameter of the stopper portion, the diameter of the stopper portion being smaller than a diameter of the connecting portion.

11. The fastener of claim 10, wherein the threaded portion comprises a substantially cone-shaped tip.

12. The fastener of claim 10, wherein the receiving groove comprises a sidewall configure to prevent the screwdriver from disengaging from the head.
